(19) United States
(12) Patent Application Publication
(10) Pub. No.: US 2017/0267071 A1
(43) Pub. Date: Sep. 21, 2017

(54) DOOR WITH INTEGRATED WINDOW AND BLIND

(71) Applicant: LIPPERT COMPONENTS, INC., Elkhart, IN (US)

(72) Inventor: Scott C. McKINNON, Union City, MI (US)

(21) Appl. No.: 15/432,271

(22) Filed: Feb. 14, 2017

Related U.S. Application Data
(60) Provisional application No. 62/310,424, filed on Mar. 18, 2016.

(51) Int. Cl. B60J 1/20; B60J 1/18; B60J 1/00; B60J 1/10

(52) U.S. Cl. CPC B60J 1/2011; B60J 1/10; B60J 1/18; B60J 1/2091; B60J 1/2066; B60J 1/006

(57) ABSTRACT

An integrated window frame and blind unit includes a frame having an inner bezel and an outer bezel configured to sandwich a wall of a structure between them. A window pane may be installed to the outer bezel to cover an opening therein. A blind unit may be inserted through a similar opening in the inner bezel and attached to a header portion and/or sill portion of the frame. The inner and/or outer bezel may include snap features to effect the attachment.

### CROSS-REFERENCE TO RELATED APPLICATION

This application claims benefit under 35 U.S.C. 119 of U.S. Provisional Patent Application No. 62/310,424, filed Mar. 18, 2016, and incorporates by reference the disclosure thereof in its entirety.

### BACKGROUND OF THE DISCLOSURE

A door for a recreational vehicle or other vehicle or structure may include a window. Window shades or blinds may be provided to selectively block the view through the window. Such blinds typically are attached to the top of the window's frame or to the door itself above the window frame. As such, installation of the window into the door involves a first process, and installation of the blinds to the door involves a second process.

### BRIEF DESCRIPTION OF THE DRAWINGS

FIG. 1 is an exploded perspective view of a window and blind assembly according to the present disclosure;

FIG. 2 is a perspective view of a window and blind assembly according to the present disclosure;

FIG. 3 is a perspective exterior view of a window and blind assembly integrated into a door with the blind in an open position according to the present disclosure;

FIG. 4 is a perspective interior view of a window and blind assembly integrated into a door with the blind in an open position according to the present disclosure;

FIG. 5 is a perspective interior view of a window and blind assembly integrated into a door with the blind in a fully closed position according to the present disclosure;

FIG. 6 is a perspective interior view of a window and blind assembly integrated into a door with the blind in a partially closed position according to the present disclosure;

FIGS. 7A-7C are a set of views of a window and blind assembly according to the present disclosure;

FIG. 8 is a perspective view of a corner of an outer bezel of a window and blind assembly according to the present disclosure;

FIG. 9 is a perspective view of a corner of an outer bezel and a glass pane of a window and blind assembly according to the present disclosure;

FIG. 10 is an interior elevation view of an inner bezel of a frame of a window and blind assembly according to the present disclosure; and

FIG. 11 is a cross-sectional side elevation view of the inner bezel of FIG. 10.

### DETAILED DESCRIPTION OF THE DRAWINGS

The drawings show an illustrative embodiment of a window and blind assembly 10 that may be integrated into a panel, for example, a door 11 or a wall (not shown). The assembly 10 includes a blind unit 12 and a window pane 14 disposed between an inner bezel 16 and an outer bezel 18 of a frame 20. The assembly 10 may be integrated into an aperture in the door or the wall (not shown), as will be discussed further below.

The blind unit 12 includes a header 22, a window covering in the form of a pleated blind 24 depending from the header, and a bottom rail 26 attached to a bottom portion of the pleated blind. A handle 28 extends from the bottom rail 26. The handle 28 is grippable by a user and operable by the user to raise and lower (or open and close) the pleated blind, as will be discussed further below. The bottom rail 26 may be sufficiently heavy to maintain the pleated blind 24 in a lowered (or closed) position. In an embodiment, an additional weight 30 may be attached to or otherwise associated with the bottom rail 26 to better enable maintenance of the pleated blind 24 in an extended position. A catch 29 may be provided proximate the bottom of the frame 20. Alternatively or additionally, a catch 29 may be provided proximate the top of the frame 20. The handle 28 may be configured to selectively engage with the catch 29 to secure the blind unit in an extended or retracted position. In further embodiments, the pleated blind could include a sill portion (not shown) configured for attachment to an interior portion of the sill of the frame 20 and cords routed among the header 22, the bottom rail 26, and the sill portion, wherein the cords are operable to maintain the bottom rail in a desired position as left by a user.

In another embodiment (not shown), a window covering in the form of a roller shade (not shown) having a roller and a fabric rollable onto and unrollable from the roller could take the place of the pleated blind 24. In such an embodiment, a bottom rail analogous to the bottom rail 26 could be attached to a bottom portion of the fabric, and a handle analogous to the handle 28 could be attached to or otherwise associated with the bottom rail or fabric. The roller could be attached to a header analogous to the header 22. The roller shade could be operated in a conventional manner. In a further embodiment (not shown), a window covering in the form of a venetian blind (not shown) having a header, a set of slats and associated slat supports, and a bottom rail could take the place of the pleated blind 24. The venetian blind could be raised and lowered and the slats could be rotated in a conventional manner. In other embodiments, the window covering could take other forms.

The window pane 14 may be made of made of glass, plastic or another suitable material. It may be, for example, single-glazed, double-gazed, or triple glazed.

The inner bezel 16 includes a web 32 having a first (or outer) surface 34 and a second (or inner) surface 36. The web 32 defines an aperture or opening 38. A first flange 40 extends from the inner surface 34 of the web 32 near a first (or inner) edge of the web defining the aperture 38. The first flange 40 may extend sufficiently far to abut against a surface of the window pane 14 when the window pane, the inner bezel 16, and the outer bezel 18 are assembled together, as will be discussed further below. The first flange 40 may, but need not, be substantially perpendicular to the web 32. An optional second flange 42 extends from an interior surface of the web 32 at or near a second (or outer) edge of the web opposite the first edge. The second flange 42 may, but need not, be substantially perpendicular to the web 32. A plurality of screw bosses 44 extends from an interior surface of the web 32 near a second (or outer) edge of the web opposite the first edge. The screw bosses 44 may, but need not, be substantially perpendicular to the web 32. Each screw boss 44 defines a corresponding aperture through the inner bezel 16. Each screw boss 44 may, but need not, define a countersink (not shown) adjacent the corresponding portion of the outer surface of the inner bezel 16. Where provided, the countersink may be configured to receive a corresponding screw head or washer (not shown) in mating, compressive engagement.

The first flange 40 defines a radially outwardly-facing outer surface and a radially inwardly-facing inner surface. The outer surface may complement a corresponding radially inwardly-facing surface defined by the aperture in the door 11 and may be slidingly received thereby.

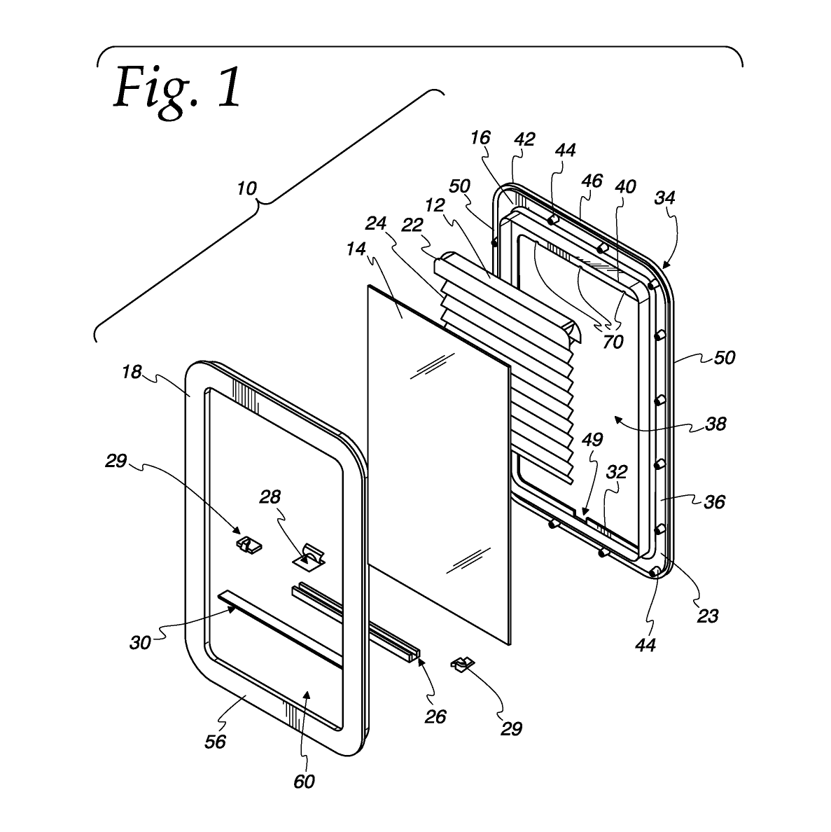

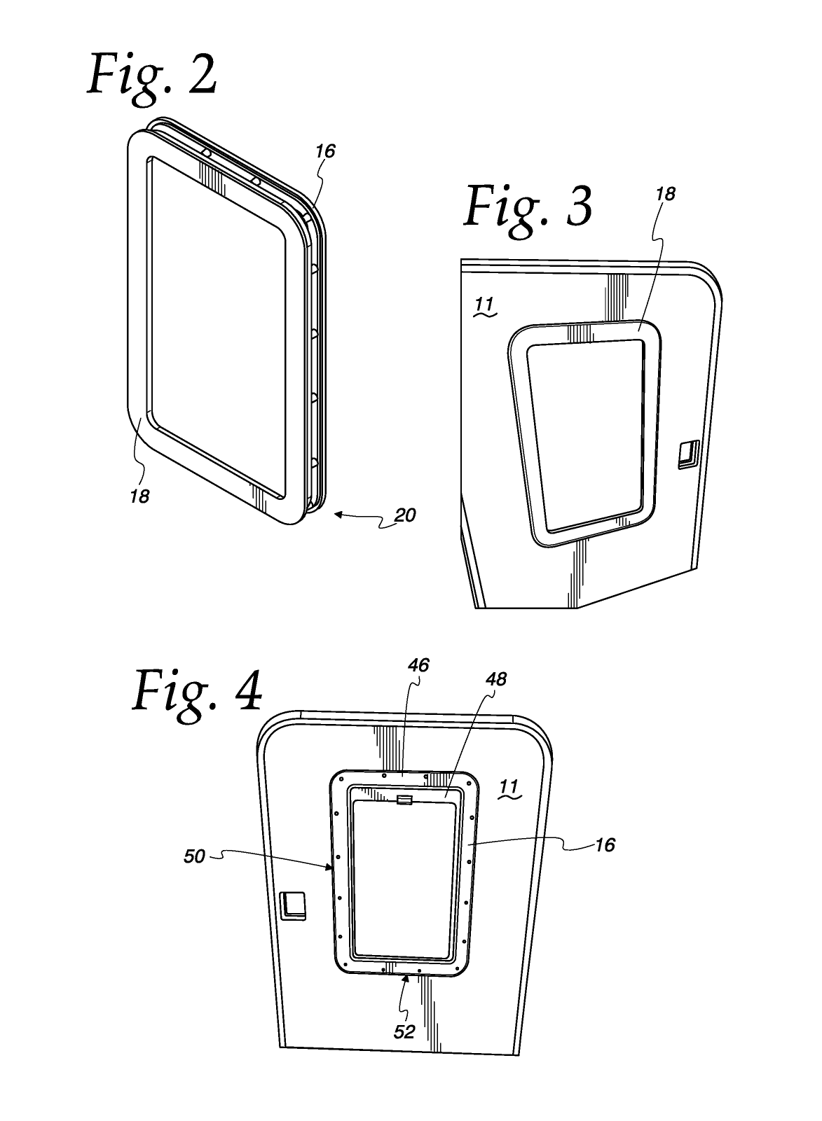

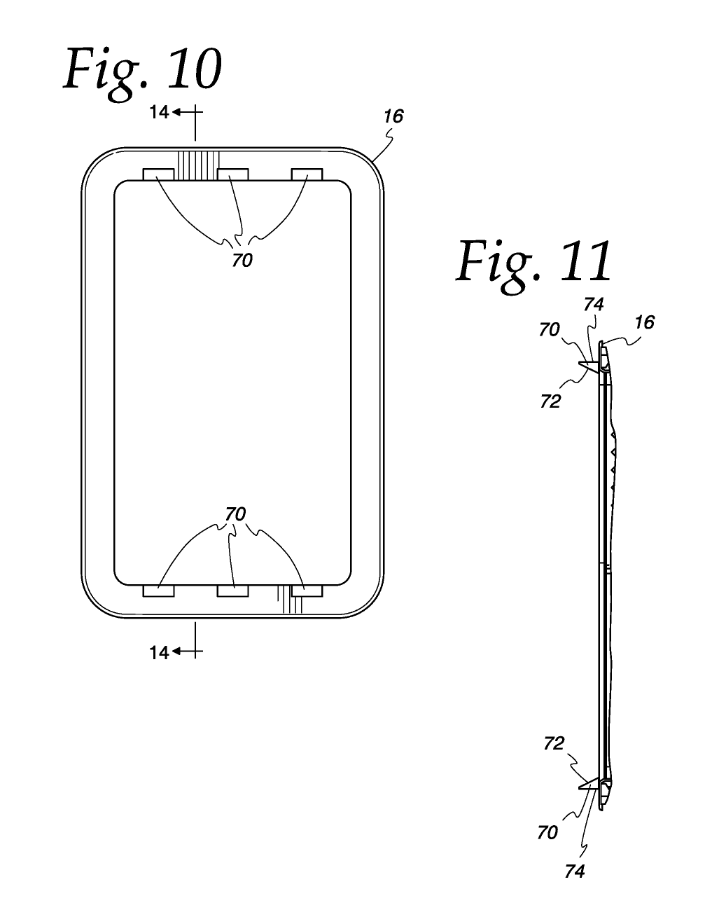

A header portion 46 of the inner bezel 16 and/or outer bezel 18 may define one or more features configured to receive a header of the blind unit 12, as will be discussed further below. For example, the header portion 46 may define one or more channels for receiving the header 22 of the blind unit 12 and thereby locating the header of the blind unit with respect to the inner bezel 16. Also, the header portion 46 may include one or more snap features for securing the blind unit 12 thereto when located therein. For example, as best shown in FIGS. 1, 10, and 11, the header portion 46 of the inner bezel 16 may include one or more tabs 70 projecting from the interior surface of the web 32 thereof. The tabs 70 are shown as having a right-triangular cross section including a ramped surface 72 and a retaining surface 74.

Alternatively or additionally, one or more tabs 70 may project from a complementary interior surface of the web 54 of the outer bezel 18. Further, one or more tabs 70 may project from a corresponding interior surface of the sill portion of the web 32 of the inner bezel 16 and/or the sill portion of the web 54 of the outer bezel 18.

Alternatively or additionally, the header portion 46 may include channels or other structures defining apertures configured to receive screws or other fasteners that may further be received in corresponding apertures in the header of the blind unit. Also, locating pins (not shown) could extend inwardly from the inner surface of the web 32 of the header portion 46. The header of the blind unit 12 could define corresponding apertures configured to receive such locating pins extending from the web.

In another embodiment, upper regions of jamb portions 50 of the inner bezel 16 and/or outer bezel 18 could define or otherwise include features similar to those described above for receiving the header of the blind unit 12. For example, snap and/or other retention features could be included in the upper regions of the jamb portions 50 of the inner and/or outer bezel 16, 18.

A lower portion of the web 32 may define a notch 49. The notch 49 may, but need not, extend from the inner edge of the web 32 to the interface between the web and the first flange 40. The notch 49 may be configured to receive at least a portion of the handle 28 attached to a bottom rail of the blind unit 12, as will be discussed further below. The catch 29 could be attached to the inner bezel 16 at or proximate the notch 48.

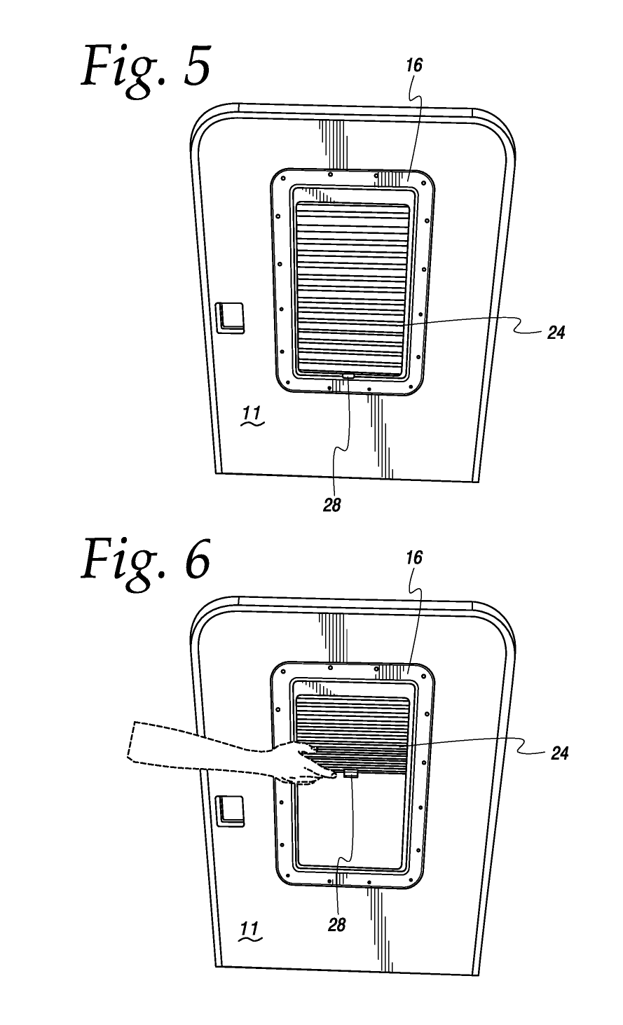

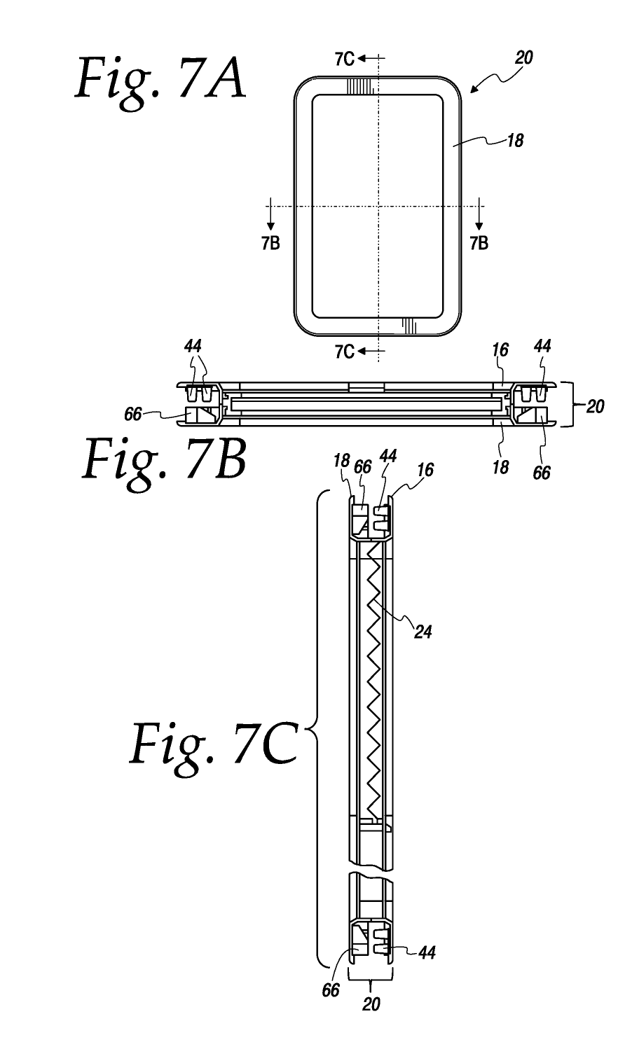

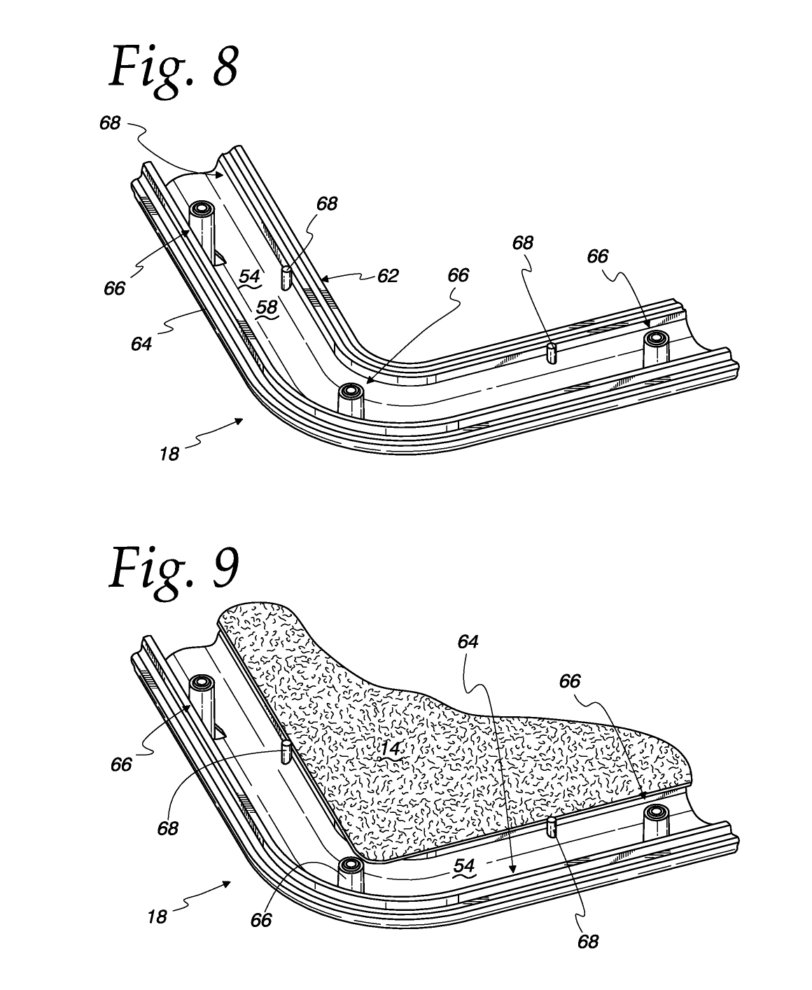

As best shown in FIGS. 4-6, an exterior surface of the inner bezel 16 may include a peripheral portion 46 and an inner portion 48 that is inset from the peripheral portion. The inner portion 48 may, but need not, have a substantially uniform width about the jamb portions 50 and the sill portion 52 of the inner bezel. This width may be sufficient to enable the inner web 32 to cover the ends and the bottom of the pleated blind 24 (or a roller shade or other substitute therefor) when the blind is deployed so that the blind and frame interact to preclude a direct line of sight between the blind and the frame 20 and into the RV. The width of the inner portion 48 of the header portion 46 may, but need not, be greater than the width of the inner portion 48 of the jamb and sill portions 50, 52. For example, the width of the inner portion 48 of the web of the header portion 46 may be sufficient to accommodate or conceal the full stacked height of the pleated blind 24 (or the height of a substitute therefor) when the blind is in a fully raised position.

The outer bezel 18 includes a web 54 having a first (or exterior) surface 56 and a second (or interior) surface 58. The web 54 defines an aperture or opening 60. A first (or inner) flange 62 extends from the interior surface 58 of the web 54 near a first (or inner) edge of the web defining the aperture 60. The first flange 62 may, but need not, be substantially perpendicular to the web 54. A second (or outer) flange 64 extends from the interior surface 58 of the web 54 at or near a second (or outer) edge of the web opposite the first edge. The second flange 64 may, but need not, be substantially perpendicular to the web 54. A plurality of screw bosses 66 corresponding to the screw bosses 44 extends from an interior surface of the web 54 near the second (or outer) edge of the web opposite the first edge. The screw bosses 66 may, but need not, be substantially perpendicular to the web 54. Each screw boss 66 is configured to receive the end of a screw in threaded engagement therewith. The free end of each screw boss 66 may abut the free end of a corresponding screw boss 44 when the inner bezel 16 is attached to the outer bezel 18. Locating tabs or posts 68 may extend from the interior surface 58 of the web 54 between the inner edge thereof and the outer edge thereof. The locating tabs 68 may be positioned and configured to receive the window pane 14 there between in a manner that substantially precludes side-to-side movement of (that is, laterally restrains) the window pane with respect to the outer bezel 18. For example, one or more locating tabs 68 could be positioned adjacent the inner flange 62 of each of the header, jamb, and sill portions of the outer bezel 18. The locating 68 tabs could include features, for example, snap features, configured to retain the window pane 14 there between and against the free end of the inner flange 62 of the outer bezel 18.

The assembly 10 may be assembled by applying an adhesive or sealant on the free end of the inner flange 62 of the outer bezel 18 and then placing the window pane 14 upon the adhesive or sealant, thereby adhering the window pane to the outer bezel. In an embodiment in which the locating tabs 68 include snap or other features to retain the window pane 14 there between, the adhesive or sealant could be omitted. The inner bezel 16 and outer bezel 18 may be placed against the door or wall so that the screw bosses 44, 66 of the inner bezel 16 and outer bezel are received within the opening therein. An optional adhesive or sealant may be applied to the outer flanges 42, 64 of the inner bezel and outer bezel 16, 18, respectively, before the inner and outer bezels are placed against the door. Screws may be inserted through the apertures in the screw bosses 44 and screwed into the screw bosses 66, thereby sandwiching the door or wall between the inner and outer bezels 16, 18. The blind unit 12 may be attached to the thus-assembled frame 20 by inserting the blind unit 12 through the aperture 38 of the inner bezel 16 and attaching it to the receiving structure of the inner bezel (and/or outer bezel 18). For example, the header 22 of the blind unit 12 could be pressed against the ramped surface(s) 72 of the tabs 70 extending from the interior surface(s) of the webs 32, 54 of the inner and/or outer bezels 16, 18, thereby deflecting the tabs, the webs and/or the header sufficiently to allow the header to move past the ramped surface(s). With the header 22 past the ramped surfaces 72, the tabs 70 or the header 22 may resiliently return to or toward their original positions, so that the header 22 may be captured and supported by the retaining surfaces 74 of the tabs 70. A sill portion of the blind unit 12, where provided, may be similarly attached to the sill portion of the frame 20.

1. A window and blind system configured for insertion into an opening defined by a panel and further for connection to the panel adjacent the opening, the system comprising:
a window pane having a first surface, a second surface, and a peripheral edge;
a blind unit having a header and a window covering operably associated with the header, the window covering selectively extendable from and retractable to the header and configured to selectively cover at least a portion of the window pane; and
a frame comprising a first bezel and a second bezel configured for attachment to the first bezel, the frame configured to receive the window pane and the blind unit between the first bezel and the second bezel;
the first bezel comprising:
a first web defining a first aperture there through and a surface engagable with a first surface of the panel and with the first surface of the window pane;
at least one first screw boss; and
a plurality of tabs extending from the first web about the aperture and collectively configured to receive and laterally restrain the window pane; and
the second bezel comprising:
a second web defining a second aperture there through, the second aperture corresponding to the first aperture;
at least one second screw boss corresponding to and registrable with the at least one first screw boss; and
a first flange extending perpendicularly from the second web, the first flange having a free end configured for abutment with the second surface of the window pane directly or through an intervening seal;
the first bezel and the second bezel configured to supportingly receive the header of the blind unit therebetween.

2. The system of claim 1, the second web extending between the first flange and the second aperture, the window covering configured to selectively cover at least a portion of the second web extending between the first flange and the second aperture.

3. The system of claim 1, wherein the second bezel comprises a channel configured to receive and laterally secure the header portion of the blind unit thereto.

4. The system of claim 3, wherein the second bezel further comprises a snap feature to fully secure the header portion of the blind unit thereto.

5. The system of claim 1, wherein the second bezel comprises at least one of a channel and a snap feature configured to receive and secure the header portion of the blind unit thereto.

6. The system of claim 1 wherein each of the first bezel and the second bezel includes a header portion, the header portion of sufficient extent to conceal the blind unit when the blind unit is supportingly received between the first and second bezel and the window covering is fully retracted to the header of the blind unit.

7. The system of claim 1 wherein the window pane and the blind unit are received between the first bezel and the second bezel.

8. The system of claim 7 further comprising screws engaged with the first and second screw bosses.

9. The system of claim 1 wherein the window pane is received within the plurality of tabs of the first bezel.

10. The system of claim 9 wherein the window pane is affixed to the first bezel in sealed engagement therewith.

11. The system of claim 1 wherein the header of the blind unit is secured to the second bezel.

12. The system of claim 10 wherein the header of the blind unit is secured to the second bezel.

13. The system of claim 12 in combination with the panel, the first web engaged with the first surface of the panel, either directly or through an intervening seal, and the second web engaged with the second surface of the panel, either directly or through an intervening seal.

14. The combination of claim 13 further comprising screws engaged with the first and second screw bosses, thereby connecting the first bezel to the second bezel.

15. The combination of claim 13 wherein the panel is a door or a wall of a recreational vehicle.

16. The system of claim 1 further comprising a seal configured for positioning between the free end of the first flange and the window pane.

17. The system of claim 1 wherein the blind unit is a roller blind.

18. The system of claim 1 wherein the blind unit is a pleated blind.

19. The system of claim 1 further comprising a catch operable to selectively secure the window covering to the frame.
